(19) United States
(12) Patent Application Publication
(10) Pub. No.: US 2024/0264307 A1
(43) Pub. Date: Aug. 8, 2024

(54) DISTANCE MEASURING DEVICE, DISTANCE MEASURING METHOD, AND DISTANCE MEASURING SENSOR

(71) Applicant: SONY SEMICONDUCTOR SOLUTIONS CORPORATION, KANAGAWA (JP)

(72) Inventor: YUTAKA NAKADA, KANAGAWA (JP)

(21) Appl. No.: 18/566,714

(22) PCT Filed: Feb. 14, 2022
(86) PCT No.: PCT/JP2022/005662

§ 371 Date: Dec. 4, 2023

(30) Foreign Application Priority Data
Jun. 15, 2021 (JP) 2021-099534

(51) Int. Cl. G01S 17/32; G01S 7/4915

(52) U.S. Cl. CPC G01S 17/32; G01S 7/4915

(57) ABSTRACT

The distance measurement time is shortened. A distance measuring device includes a light source unit, a light reception signal generation unit, a time-of-flight detection unit, and a distance detection unit. The light source unit continuously emits reference emission light emitted in synchronization with a reference clock signal and delayed emission light emitted in synchronization with a delayed clock signal having a delay phase at a same cycle as the reference clock signal in a predetermined emission cycle for every predetermined measurement cycle. The light reception signal generation unit includes a light receiving unit that receives reflected light emitted from the light source unit and reflected by an object, detects reflected light based on the reference emission light and reflected light based on the delayed emission light in synchronization with the reference clock signal, and generates a reference light reception signal and a delayed light reception signal. The time-of-flight detection unit detects time-of-flight data including a reference time of flight based on the generated reference light reception signal and a delayed time of flight based on the generated delayed light reception signal for every measurement cycle. The distance detection unit detects a distance to the object based on the detected time-of-flight data.

### FIELD

The present disclosure relates to a distance measuring device, a distance measuring method, and a distance measuring sensor.

### BACKGROUND

A distance measuring device based on a time of flight (ToF) method that measures a distance to an object by irradiating the object with light and measuring a time for light to reciprocate between the object and the distance measuring device is used. As the ToF method, a direct ToF method of directly measuring a reciprocation time of light using a timer or the like is known. In the direct ToF method, time measurement is started at the timing of emitting light. Reflected light in which the light is reflected by the object is received by a light receiving device, and a light reception signal is generated. Time measurement is stopped by detecting the light reception signal at a predetermined capturing (sampling) cycle. The time for flight can be detected by this time measurement processing.

The accuracy and resolution of the distance measurement change according to the sampling cycle described above. As the sampling cycle is shortened, the distance measurement accuracy and resolution can be improved. For example, with the sampling cycle of 1 ns, 15 cm of resolution of distance measurement can be obtained. The sampling cycle of 1 ns corresponds to a sampling frequency of 1 GHz, requiring high-speed processing.

As such a distance measuring device, there has been proposed a distance measuring device that emits pulsed light in synchronization with a standard clock pulse, receives pulsed light reflected from an object, performs sampling in synchronization with the standard clock pulse to detect the received pulsed light, and measures a time of flight (see, for example, Patent Literature 1). In this distance measuring device, pulsed light synchronized with a standard clock pulse is emitted and received a plurality of times, and a histogram of time segments received at the time of receiving the pulsed light is generated. Thereafter, the pulse light synchronized with the clock pulse delayed by ¼, ½, and ¾ of the cycle of the standard clock pulse is emitted and received a plurality of times to form a histogram. By calculating the average flight time of the detected flight times based on the centroid positions of these four histograms, it is possible to obtain resolution in a cycle shorter than the cycle of the reference clock pulse.

### CITATION LIST

### Patent Literature

Patent Literature 1: JP 2006-329902 A

### SUMMARY

### Technical Problem

However, the above-described conventional technology has a problem that it requires four times of histogram formation, which makes the time required for distance measurement long.

The present disclosure proposes a distance measuring measure, a distance measuring method, and a distance measuring sensor that shorten a distance measuring time.

### Solution to Problem

A distance measuring device according to the present disclosure includes: a light source unit that continuously emits reference emission light emitted in synchronization with a reference clock signal and delayed emission light emitted in synchronization with a delayed clock signal having a delay phase at a same cycle as the reference clock signal in a predetermined emission cycle for every predetermined measurement cycle; a light reception signal generation unit that includes a light receiving unit that receives reflected light emitted from the light source unit and reflected by an object, detects the reflected light based on the reference emission light and the reflected light based on the delayed emission light in synchronization with the reference clock signal, and generates a reference light reception signal and a delayed light reception signal; a time-of-flight detection unit that detects time-of-flight data including a reference time of flight based on the generated reference light reception signal and a delayed time of flight based on the generated delayed light reception signal for the every measurement cycle; and a distance detection unit that detects a distance to the object based on the detected time-of-flight data.

### BRIEF DESCRIPTION OF DRAWINGS

FIG. 1 is a diagram depicting a configuration example of a distance measuring device according to a first embodiment of the present disclosure.

FIG. 2 is a diagram depicting an example of reference emission light and delayed emission light according to the first embodiment of the present disclosure.

FIG. 3 is a diagram depicting a configuration example of a light reception signal generation unit according to an embodiment of the present disclosure.

FIG. 4 is a diagram depicting a configuration example of a light receiving unit according to an embodiment of the present disclosure.

FIG. 5 is a diagram depicting an example of an operation of a light reception signal generation unit according to an embodiment of the present disclosure.

FIG. 6 is a diagram depicting a configuration example of a time-of-flight detection unit according to an embodiment of the present disclosure.

FIG. 7 is a diagram depicting an example of a time-of-flight histogram according to an embodiment of the present disclosure.

FIG. 8 is a diagram depicting a configuration example of a measurement detection unit according to an embodiment of the present disclosure.

FIG. 9 is a diagram depicting an example of a second time-of-flight histogram according to an embodiment of the present disclosure.

FIG. 10 is a diagram depicting a generation example of the second time-of-flight histogram according to an embodiment of the present disclosure.

FIG. 11 is a diagram depicting an example of distance measuring processing according to an embodiment of the present disclosure.

FIG. 12 is a diagram depicting a configuration example of a distance measuring device according to a second embodiment of the present disclosure.

FIG. 13 is a diagram depicting an example of emission light according to a first modification of an embodiment of the present disclosure.

FIG. 14 is a diagram depicting an example of a clock signal according to a second modification of an embodiment of the present disclosure.

### DESCRIPTION OF EMBODIMENTS

Hereinafter, embodiments of the present disclosure will be described in detail with reference to the drawings. The description will be given in the following order. In each of the following embodiments, the same portions are denoted by the same reference signs, and repetitive description will be omitted.
1. First Embodiment
2. Second Embodiment
3. Modification

### 1. First Embodiment

### [Configuration of Distance Measuring Device]

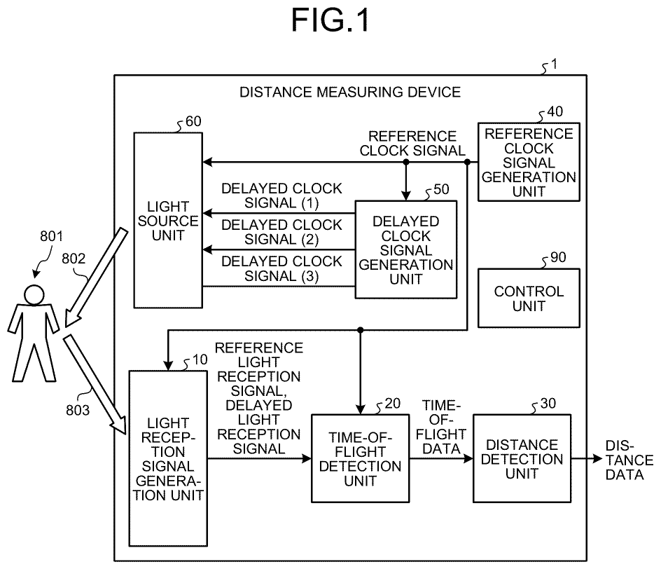

FIG. 1 is a diagram depicting a configuration example of a distance measuring device according to a first embodiment of the present disclosure. The drawing is a block diagram illustrating a configuration example of a distance measuring device 1. The distance measuring device 1 measures a distance to an object by measuring the time for light to take to flight between the object and the device. The drawing illustrates an example in which the distance measuring device 1 emits emission light 802 to an object 801, detects reflection light 803 obtained by reflecting the emission light 802 by the object 801, and measures a time of flight from the emission of the emission light 802 until the detection of the reflection light 803 to detect the distance to the object 801.

The distance measuring device 1 includes a reference clock signal generation unit 40, a delayed clock signal generation unit 50, a light source unit 60, a light reception signal generation unit 10, a time-of-flight detection unit 20, a distance detection unit 30, and a control unit 90.

The reference clock signal generation unit 40 generates a reference clock signal. The reference clock signal generates a clock signal serving as a reference of the operation of a logic circuit of the distance measuring device 1. As the reference clock signal, for example, a rectangular wave of 1 GHz may be used. The generated reference clock signal is output to the delayed clock signal generation unit 50, the light source unit 60, the light reception signal generation unit 10, and the time-of-flight detection unit 20.

The delayed clock signal generation unit 50 generates a delayed clock signal based on the reference clock signal. The delayed clock signal is a clock signal having the same cycle as the reference clock signal and a delayed phase. The drawing illustrates an example in which the delayed clock signal generation unit 50 generates three delayed clock signals (delayed clock signal (1), delayed clock signal (2), and delayed clock signal (3)). The delayed clock signal (1), the delayed clock signal (2), and the delayed clock signal (3) are clock signals delayed from the reference clock signal by 90 degrees, 180 degrees, and 270 degrees, respectively. The generation of the delayed clock signals may be performed by, for example, a phase locked loop (PLL) circuit. The generated delayed clock signal (1), delayed clock signal (2), and delayed clock signal (3) are output to the light source unit 60.

The light source unit 60 emits the emission light 802. The light source unit 60 includes a light emitting device that emits light and a drive circuit that drives the light emitting device and emits reference emission light and delayed emission light based on the reference clock signal and the delayed clock signal. A laser diode may be used as the light emitting device, for example. The reference emission light is pulsed emission light emitted in synchronization with the reference clock signal. The delayed emission light is pulsed emission light emitted in synchronization with the delayed clock signal.

The light source unit 60 continuously outputs the reference emission light and the delayed emission light in a predetermined emission cycle. The pulse widths of the reference emission light and the delayed emission light may be, for example, the same as the cycle of the reference clock signal. The emission cycle may be, for example, a cycle of five times the cycle of the reference clock signal. The light source unit 60 repeatedly emits the reference emission light and the delayed emission light for each emission cycle for every predetermined measurement cycle. Here, the measurement cycle represents a unit cycle in which the reference emission light and the delayed emission light are emitted. This measurement cycle corresponds to a cycle of updating a time-of-flight histogram to be described later. Details of the reference emission light and the delayed emission light will be described later.

The light reception signal generation unit 10 includes a light receiving unit that receives the reflection light 803 obtained by the emission light 802 from the light source unit 60 being reflected by the object 801, and generates a light reception signal. The light reception signal generation unit 10 detects each reflection light based on the above-described reference emission light and delayed emission light in synchronization with the above-described reference clock signal, and generates a reference light reception signal and a delayed light reception signal. The generated reference light reception signal and delayed light reception signal are output to the time-of-flight detection unit 20. Details of the configuration of the light reception signal generation unit 10 will be described later.

The time-of-flight detection unit 20 detects a time of flight based on the reference light reception signal and the delayed light reception signal. The time-of-flight detection unit 20 detects a time of flight by measuring the time from emission of the reference emission light and the delayed emission light until detection of the reference light reception signal and the delayed light reception signal. In addition, the time-of-flight detection unit 20 generates time-of-flight data including a reference time of flight and a delayed time of flight based on the reference light reception signal and the delayed light reception signal.

For example, a time-of-flight histogram representing the time of flight as a frequency may be applied to the time-of-flight data. For example, the cycle of the reference clock signal may be adopted as the width of the bins of the time-of-flight histogram. The light source unit 60 emits the reference emission light and the delayed emission light for every measurement cycle. As described above, the time-of-flight detection unit 20 emits the reference emission light and the delayed emission light for every measurement cycle. The light reception signal generation unit 10 detects the reference light reception signal and the delayed light reception signal based on the reference emission light and the delayed emission light, and outputs the reference light reception signal and the delayed light reception signal to the time-of-flight detection unit 20. The time-of-flight detection unit 20 updates the histogram in accordance with the output reference light reception signal and delayed light reception signal. Specifically, the time-of-flight detection unit 20 adds the value “1” to a bin corresponding to the detection time of the reference light reception signal and the delayed light reception signal for every measurement cycle. This is performed a predetermined number of times to generate a time-of-flight histogram. The time-of-flight detection unit 20 outputs the generated time-of-flight histogram as time-of-flight data to the distance detection unit 30. Details of the configuration of the time-of-flight detection unit 20 will be described later.

The distance detection unit 30 detects the distance to the object 801 based on the time-of-flight data output from the time-of-flight detection unit 20. The distance detection unit 30 detects the time of flight to the object 801 based on the time-of-flight histogram and detects the distance to the object 801 based on the detected time of flight. The distance detection unit 30 outputs the detected distance as distance data to a device outside the distance measuring device 1. Details of the configuration of the distance detection unit 30 will be described later.

The control unit 90 controls the entire distance measuring device 1. Further, as will be described later, the control unit 90 can set the measurement cycle, the emission cycle, and the frequency of the reference clock signal.

### [Reference Emission Light and Delayed Emission Light]

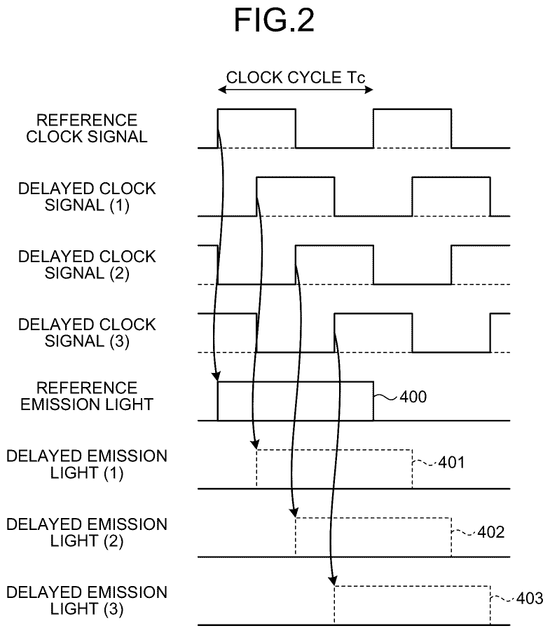

FIG. 2 is a diagram depicting an example of the reference emission light and the delayed emission light according to the first embodiment of the present disclosure. The drawing illustrates a relationship between the reference clock signal generated by the reference clock signal generation unit 40, the delayed clock signal generated by the delayed clock signal generation unit 50, and the reference emission light and the delayed emission light emitted by the light source unit 60. In the drawing, “reference clock signal” represents the reference clock signal output from the reference clock signal generation unit 40. As illustrated in the drawing, the reference clock signal is a rectangular wave. The clock cycle of the reference clock signal is represented by Tc. “Delayed clock signal (1)”, “delayed clock signal (2)”, and “delayed clock signal (3)” represent the delayed clock signals generated by the delayed clock signal generation unit 50. These clock signals are rectangular waves with phases delayed from the reference clock signal by 90 degrees, 180 degrees, and 270 degrees, respectively.

“Reference emission light” in the drawing represents the reference emission light emitted from the light source unit 60. “Delayed emission light (1)”, “delayed emission light (2)”, and “delayed emission light (3)” represent delayed emission light emitted from the light source unit 60. A rectangular region in the drawing represents a period during which light is emitted. The light source unit 60 emits reference emission light 400 in synchronization with the reference clock signal. Next, the light source unit 60 emits delayed emission light 401 in synchronization with the delayed clock signal (1). Next, the light source unit 60 emits delayed emission light 402 in synchronization with the delayed clock signal (2). Next, the light source unit 60 emits delayed emission light 403 in synchronization with the delayed clock signal (3). As illustrated in the drawing, the reference emission light 400, the delayed emission light 401, the delayed emission light 402, and the delayed emission light 403 may be configured to have the same pulse width as the cycle of the reference clock signal. The drawing illustrates phases of the reference emission light and the delayed emission light with respect to the reference clock signal, and emission timings of the delayed emission light 401, the delayed emission light 402, and the delayed emission light 403 are different from those in the drawing. As described above, the delayed emission light 401, the delayed emission light 402, and the delayed emission light 403 are emitted every predetermined emission cycle after the emission of the reference emission light.

### [Light Reception Signal Generation Unit]

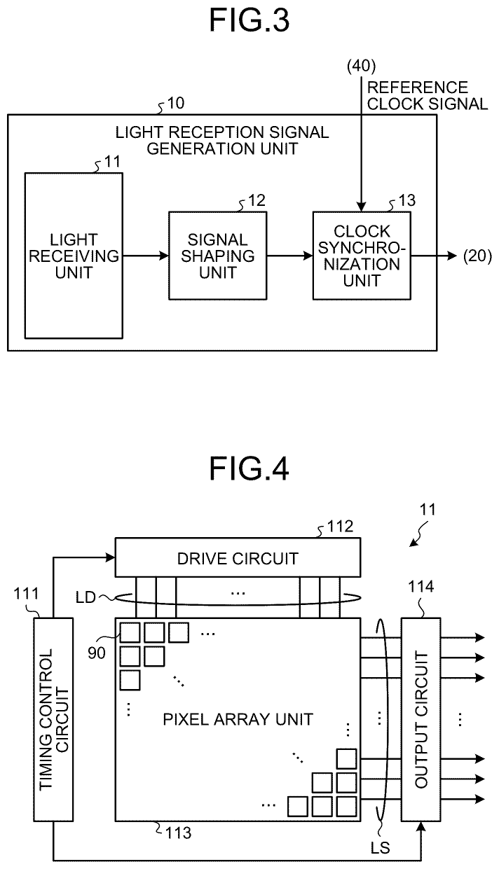

FIG. 3 is a diagram depicting a configuration example of the light reception signal generation unit according to an embodiment of the present disclosure. The drawing is a block diagram illustrating a configuration example of the light reception signal generation unit 10. The light reception signal generation unit 10 in the drawing includes a light receiving unit 11, a signal shaping unit 12, and a clock synchronization unit 13.

The light receiving unit 11 detects reflected light based on the reference emission light and the delayed emission light. The light receiving unit 11 detects light with a photoelectric conversion device that performs photoelectric conversion of incident light. The light receiving unit 11 may include, for example, a plurality of pixels having photoelectric conversion devices. The pixel generates and outputs a signal based on photoelectric conversion of the photoelectric conversion devices. Details of the configuration of the light receiving unit 11 will be described later.

The signal shaping unit 12 shapes a signal output from the light receiving unit 11. In the shaping of this signal, an analog signal output from the light receiving unit 11 is binarized and converted into a digital signal, and the digital signal is output to the clock synchronization unit 13. The binarization of the analog signal may be performed by, for example, a comparator.

The clock synchronization unit 13 synchronizes the signal output from the signal shaping unit 12 with the clock signal. The clock synchronization unit 13 converts the digital signal output from the signal shaping unit 12 into a signal synchronized with the reference clock signal, and outputs the signal to the time-of-flight detection unit 20. The clock synchronization unit 13 may include, for example, two D-type flip-flops connected in series. The reference clock signal can be input to the clock terminals of the two D-type flip-flops.

### [Light Receiving Unit]

FIG. 4 is a diagram depicting a configuration example of the light receiving unit according to an embodiment of the present disclosure. The drawing is a block diagram illustrating a configuration example of the light receiving unit 11. The light receiving unit 11 in the drawing includes a pixel array unit 113, a timing control circuit 111, a drive circuit 112, and an output circuit 114.

The pixel array unit 113 includes a plurality of pixels 90 arranged in a two-dimensional lattice pattern. To the plurality of pixels 90, a pixel drive line LD (vertical direction in the drawing) is connected for each column, and an output signal line LS (horizontal direction in the drawing) is connected for each row. One end of the pixel drive line LD is connected to an output end corresponding to each column of the drive circuit 112, and one end of the output signal line LS is connected to an input end corresponding to each row of the output circuit 114. A photoelectric conversion device is disposed in each pixel 90. As the photoelectric conversion device, a single photon avalanche diode (SPAD) may be used, for example. The SPAD is a photoelectric conversion device capable of detecting incidence of a single photon.

The drive circuit 112 includes a shift register, an address decoder, and the like, and drives each pixel 90 of the pixel array unit 113 at the same time for all pixels, in units of columns, or the like. The drive circuit 112 sequentially outputs a selection control signal to the pixel drive line LD to select the pixels 90 to be used for detecting incidence of photons in units of columns.

A signal (light reception signal) output from each pixel 90 of the column selectively scanned by the drive circuit 112 is input to the output circuit 114 through each of the output signal lines LS. The output circuit 114 amplifies and outputs the light reception signal input from each pixel 90. The light reception signal is a pulsed signal based on incidence of photons.

The timing control circuit 111 includes a timing generator or the like that generates various timing signals. The control circuit controls the drive circuit 112 and the output circuit 114 based on the various timing signals generated by the timing generator.

### [Operation of Light Reception Signal Generation Unit]

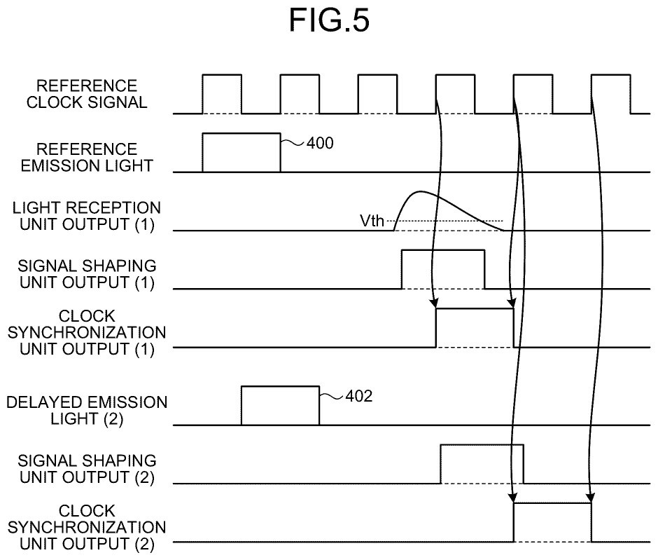

FIG. 5 is a diagram depicting an example of an operation of the light reception signal generation unit according to an embodiment of the present disclosure. The drawing is a timing chart for explaining the operation of the light reception signal generation unit 10. “Reference clock signal”, “reference emission light”, and “delayed emission light (2)” in the drawing are the same as those in FIG. 2. “Light reception unit output (1)”, “signal shaping unit output”, and “clock synchronization unit output” represent an output signal of the light receiving unit 11, an output signal of the signal shaping unit 12, and an output signal of the clock synchronization unit 13, respectively. Of these, a signal to which “(1)” is added represents an output signal corresponding to the reference emission light 400, and a signal to which “(2)” is added represents an output signal corresponding to the delayed emission light 402.

When the reference emission light 400 is emitted, reflection light is detected after the time corresponding to the time of flight elapses, and a signal is output from the light receiving unit 11. In a case where the SPAD is used for the light receiving device of the light receiving unit 11, this signal is a pulsed signal as illustrated in the drawing. This signal is binarized by the signal shaping unit 12 and shaped into a digital signal. “Vth” in the drawing represents a threshold value at the time of binarization. The digital signal is converted into a signal synchronized with the reference clock signal by the clock synchronization unit 13. This drawing illustrates an example of conversion into a signal synchronized with the rise of the reference clock signal. This clock synchronization enables a digital circuit that operates in synchronization with the reference clock signal to process the light reception signal.

In the emission of the delayed emission light 402 as well, the output signal of the light receiving unit 11 is binarized and converted into a signal synchronized with the reference clock signal. The delayed emission light 401 and the delayed emission light 403 (not illustrated) are also binarized and synchronized with the reference clock signal. In this manner, the light reception signal based on the delayed emission light emitted in synchronization with the delayed clock signal becomes a signal synchronized with the reference clock signal.

### [Time-of-Flight Detection Unit]

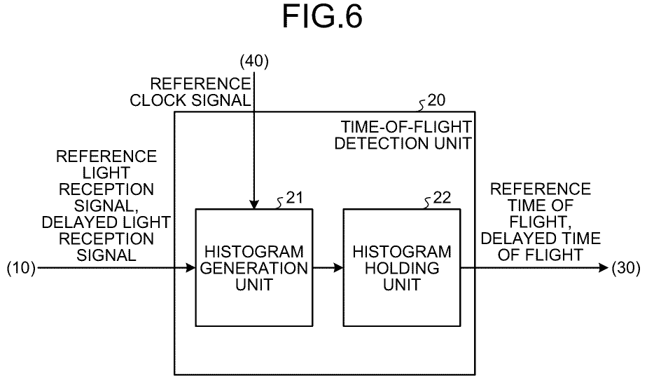

FIG. 6 is a diagram depicting a configuration example of the time-of-flight detection unit according to an embodiment of the present disclosure. The drawing is a block diagram illustrating a configuration example of the time-of-flight detection unit 20. The time-of-flight detection unit 20 in the drawing includes a histogram generation unit 21 and a histogram holding unit 22.

The histogram holding unit 22 holds the time-of-flight histogram generated by the histogram generation unit 21. The histogram holding unit 22 includes a plurality of storage units corresponding to each bin of the time-of-flight histogram.

The histogram generation unit 21 generates a time-of-flight histogram based on the reference light reception signal and the delayed light reception signal. The histogram generation unit 21 causes the histogram holding unit 22 to hold the generated time-of-flight histogram. As described above, the time-of-flight histogram can generate a histogram in which the cycle of the reference clock signal is used as the bin width. When the reference clock signal is 1 GHz, the bin width is 1 ns. This corresponds to a distance of approximately 15 cm. When the distance measurement range is set to 15 m, the number of bins of the time-of-flight histogram is 100.

Every time the reference light reception signal and the delayed light reception signal are input, the histogram generation unit 21 adds the value “1” to the frequency of the bin corresponding to the detection time. Specifically, the histogram holding unit 22 adds the value “1” to the value in the storage unit of the corresponding bin of the histogram holding unit 22 to update the time-of-flight histogram. The histogram generation unit 21 may be composed of, for example, a shift register having the number of bins as a bit width. In the above-described example, the histogram generation unit 21 may be composed of a 100-bit shift register. In this shift register, shifting is started in synchronization with the emission of the reference emission light 400, and the output signal of the light receiving unit 11 including the reference light reception signal and the delayed light reception signal is input while being shifted in synchronization with the reference clock signal, whereby the shift data can be stored in the bin corresponding to the flight time. The time-of-flight histogram can be generated by updating the value of the storage unit of the histogram holding unit 22 according to the shift data of each bit of the shift register.

The time-of-flight detection unit 20 detects the reference light reception signal and the delayed light reception signal and updates the time-of-flight histogram in one measurement cycle. This measurement cycle may be repeated, for example, 25 times. In a case where the pixel array unit 113 described in FIG. 4 includes a plurality of pixels 90, measurement is performed for each pixel 90 to generate a plurality of time-of-flight histograms.

### [Time-of-Flight Histogram]

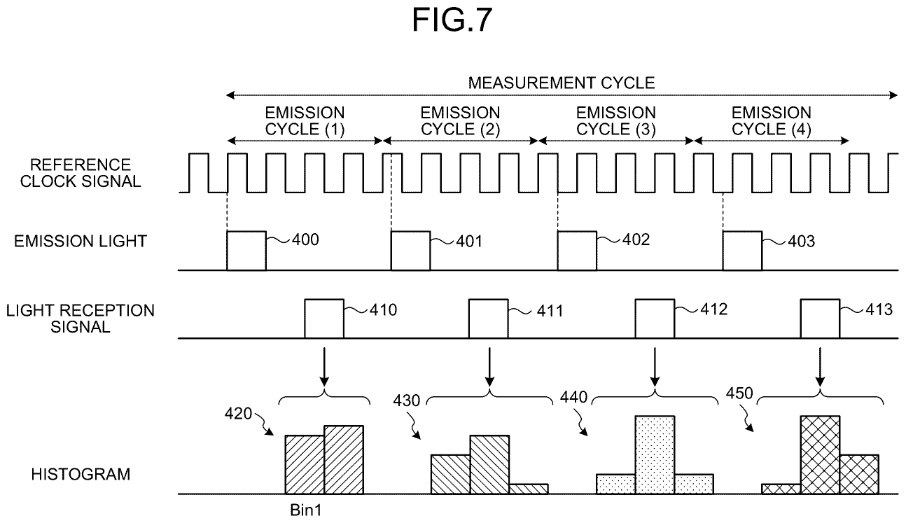

FIG. 7 is a diagram depicting an example of a time-of-flight histogram according to an embodiment of the present disclosure. This drawing illustrates an example of a time-of-flight histogram generated by the histogram generation unit 21. “Reference clock signal” in the drawing represents a waveform of the reference clock signal as in FIG. 2. “Emission light” represents pulsed light of the reference emission light 400, the delayed emission light 401, the delayed emission light 402, and the delayed emission light 403. “Light reception signal” represents the reference light reception signal 410, the delayed light reception signal 411, the delayed light reception signal 412, and the delayed light reception signal 413. These signals are light reception signals corresponding to the reference emission light 400, the delayed emission light 401, the delayed emission light 402, and the delayed emission light 403, respectively. In one measurement cycle, emission of emission light and detection of a light reception signal are sequentially performed for each emission cycle, and a time-of-flight histogram is generated. This measurement cycle is performed 25 times as described above.

As described above, the reference emission light 400, the delayed emission light 401, the delayed emission light 402, and the delayed emission light 403 are emitted at timings shifted from the reference clock signal by 0 degrees, 90 degrees, 180 degrees, and 270 degrees, respectively. Since the reference emission light 400, the delayed emission light 401, the delayed emission light 402, and the delayed emission light 403 are emitted with a shift by the emission cycle, the corresponding light reception signal is also detected at a time shifted by the emission cycle. “Histogram” in the drawing represents histograms corresponding to the reference light reception signal 410, the delayed light reception signal 411, the delayed light reception signal 412, and the delayed light reception signal 413. A histogram 420 in the drawing is a histogram corresponding to the reference emission light 400. A histogram 430 is a histogram corresponding to the delayed emission light 401. A histogram 440 is a histogram corresponding to the delayed emission light 402. A histogram 450 is a histogram corresponding to the delayed emission light 403. For convenience, these histograms are formed in two to three bins. “Bin1” in the drawing represents the bin width. As described above, this Bin1 is 1 ns.

In this manner, the histograms 420, 430, 440, and 450 can be formed at discrete positions in the time-of-flight histogram. The reference time of flight can be detected from the histogram 420, and the delayed time of flight can be detected from the histograms 430, 440, and 450. A time-of-flight histogram including the reference time of flight and the delayed time of flight can be generated.

### [Distance Detection Unit]

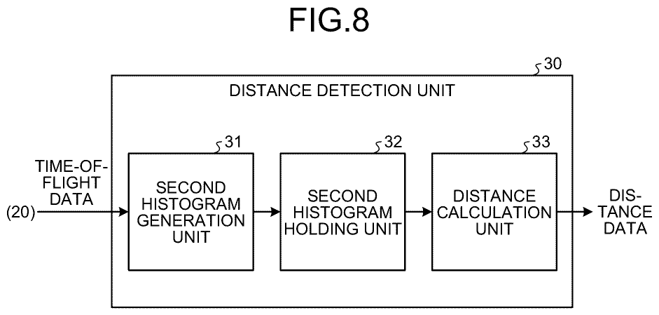

FIG. 8 is a diagram depicting a configuration example of a measurement detection unit according to an embodiment of the present disclosure. The drawing illustrates a configuration example of the distance detection unit 30. The distance detection unit 30 in the drawing includes a second histogram generation unit 31, a second histogram holding unit 32, and a distance calculation unit 33.

The second histogram generation unit 31 generates a second time-of-flight histogram. Here, the second time-of-flight histogram is a time-of-flight histogram configured to have a bin width based on a phase difference between the reference clock signal and the delayed clock signal. The second histogram generation unit 31 generates the second time-of-flight histogram based on the time-of-flight histogram output from the time-of-flight detection unit. Details of the generation of the second time-of-flight histogram will be described later.

The second histogram holding unit 32 holds the second time-of-flight histogram generated by the second histogram generation unit 31.

The distance calculation unit calculates the distance to the object 801. The distance calculation unit 33 calculates the flight distance from the second time-of-flight histogram and calculates the distance to the object 801 based on the calculated flight time. The distance calculation unit 33 outputs the calculated distance as distance data.

### [Second Time-of-Flight Histogram]

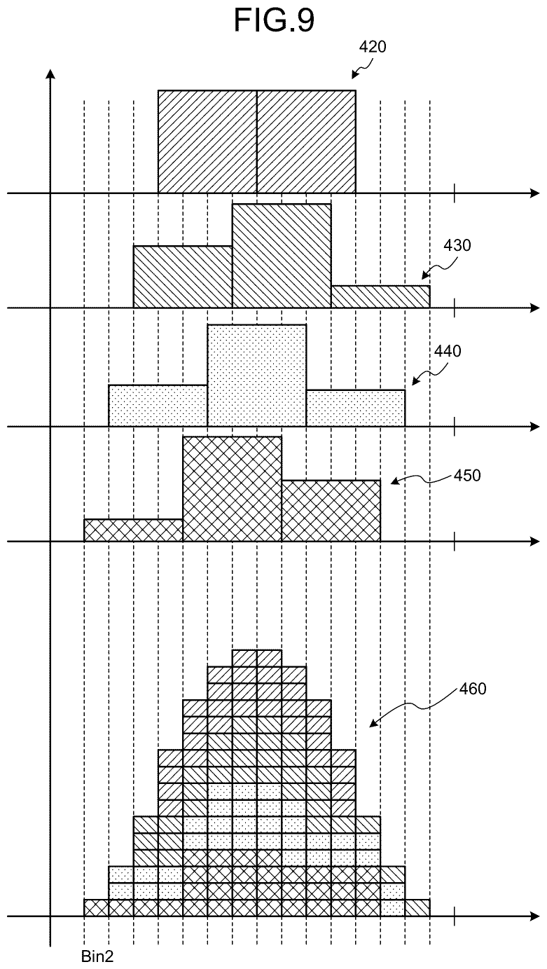

FIG. 9 is a diagram depicting an example of the second time-of-flight histogram according to an embodiment of the present disclosure. This drawing illustrates an example of a second time-of-flight histogram 460 generated by the second histogram generation unit 31. “Bin2” in the drawing represents a bin width of the second time-of-flight histogram. This Bin2 is a width corresponding to the phase difference between the reference emission light and the delayed emission light. In the drawing, it is a period corresponding to a phase difference of 90 degrees between the reference emission light 400 and the delayed emission light 401. Thus, Bin2 is 0.25 ns, which is a cycle of ¼ of the cycle of the reference clock signal.

In the drawing, the histograms 420, 430, 440, and 450 are obtained by extracting the histograms 420, 430, 440, and 450 of FIG. 7 from the time-of-flight histogram. The second time-of-flight histogram can be generated by shifting and adding the histograms 420, 430, 440, and 450 according to the delay (phase difference) when the corresponding emission light is emitted.

Specifically, since the corresponding emission light is the reference emission light 400, the histogram 420 sets the shift amount to the value “0” and holds the shift amount in the second histogram holding unit 32. For the histogram 430, since the corresponding emission light is the delayed emission light 401, the shift amount corresponding to 90 degrees is 0.25 ns (Bin2). Thus, the histogram 430 is shifted by one bin to the left side of the drawing and added to the frequency held in the second histogram holding unit 32. For the histogram 440, since the corresponding emission light is the delayed emission light 402, the shift amount corresponding to 180 degrees is 0.5 ns (Bin2×2). Thus, the histogram 440 is shifted by two bins to the left side of the drawing and added to the frequency held in the second histogram holding unit 32. For the histogram 450, since the corresponding emission light is the delayed emission light 403, the shift amount corresponding to 270 degrees is 0.75 ns (Bin2×3). Thus, the histogram 450 is shifted by three bins to the left side of the drawing and added to the frequency held in the second histogram holding unit 32.

The second time-of-flight histogram can be generated through the above procedure. As illustrated in the drawing, the second time-of-flight histogram has a bins width of ¼ of the time-of-flight histogram.

The distance calculation unit 33 can detect the time of flight from the maximum value of the second time-of-flight histogram. The distance calculation unit 33 calculates the distance to the object 801 using the detected time of flight. The distance D to the object 801 may be calculated by the following equation.

$$D = c \times Tf / 2$$

Here, c represents the speed of light. If represents the detected time of flight.

### [Generation of Second Time-of-Flight Histogram]

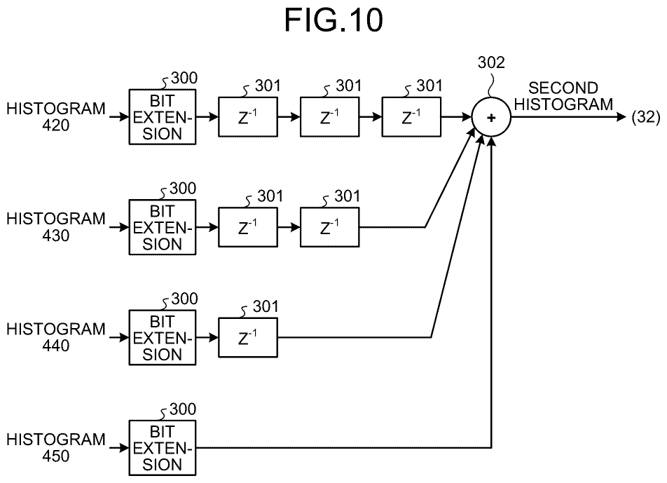

FIG. 10 is a diagram depicting a generation example of the second time-of-flight histogram according to an embodiment of the present disclosure. This drawing illustrates a generation example of the second time-of-flight histogram 460 in the second histogram generation unit 31. In the drawing, a bit extension 300 extends the bit width of the histogram 420 or the like. The bit extension 300 in the drawing extends the bit width to a width of 4 bits. Z⁻¹ 301 represents a delay. In the drawing, the frequency data of the histogram 420 is delayed by 0.25 ns. An addition unit 302 in the drawing sequentially adds data based on the histograms 420, 430, 440, and 450.

First, the second histogram generation unit 31 extracts the histograms 420, 430, 440, and 450 from the time-of-flight histogram. The extracted histograms are represented by h1[i], h2[i], h3[i], and h4[i], respectively. These h1[i] and the like represent the frequency of a bin. The subscript i represents the bin of each histogram. In the drawing, i is 0 to 2. Next, the second histogram generation unit 31 performs bit extension on these histograms. This causes h1[0], h1[1], and h1[2] to be extended to h1[0:3], h1[4:7], and h [8:11], respectively, in the histogram 420. Next, the extended histogram is delayed by the number of Z⁻¹ 301 and added by the addition unit 302. When the second time-of-flight histogram is represented by y[i] (i=0 to 14), the following equations are formed.

$$\begin{matrix}y [ 0 ] = h 4 [ 0 ] \\ y [ 1 ] = h 4 [ 1 ] + h 3 [ 0 ] \\ y [ 2 ] = h 4 [ 2 ] + h 3 [ 1 ] + h 2 [ 0 ] \\ y [ 3 ] = h 4 [ 3 ] + h 3 [ 2 ] + h 2 [ 1 ] + h 1 [ 0 ] \\ y [ 4 ] = h 4 [ 4 ] + h 3 [ 3 ] + h 2 [ 2 ] + h 1 [ 1 ]\end{matrix}$$

The second time-of-flight histogram 460 can be generated by repeating the same calculation.

The second histogram generation unit 31 may be configured by an electronic circuit that performs the processing illustrated in FIG. 10. For example, the second histogram generation unit 31 may be composed of a filter circuit having a tap coefficient of 1 and a number of taps of 4.

### [Generation of Second Time-of-Flight Histogram]

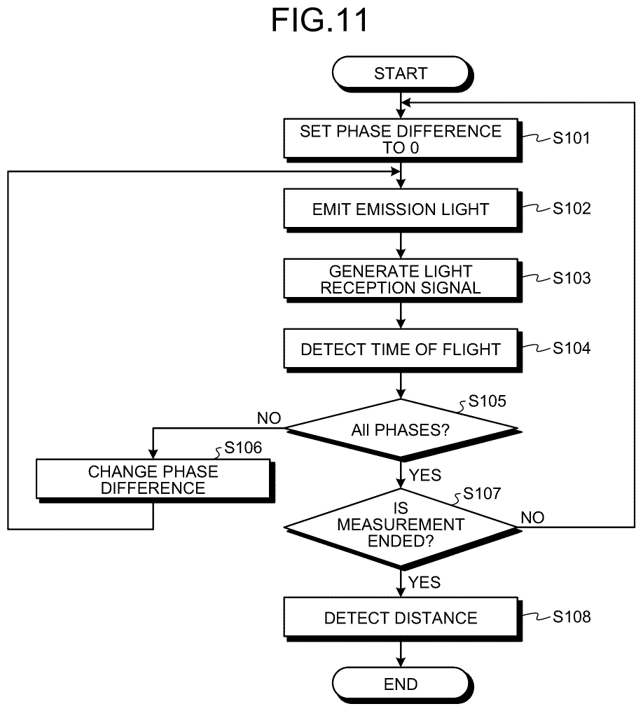

FIG. 11 is a diagram depicting an example of distance measuring processing according to an embodiment of the present disclosure. The drawing is a flowchart illustrating an example of distance measuring processing in the distance measuring device 1. First, the phase of the emission light in the light source unit 60 is set to 0 (Step S101). This phase difference corresponds to a phase difference with respect to the reference clock signal. The case where the phase difference is 0 corresponds to the emission of the reference emission light 400. Next, the light source unit 60 emits emission light at the set phase difference (Step S102). Next, the light reception signal generation unit 10 generates a light reception signal (Step S103). Next, the time-of-flight detection unit 20 detects the time of flight (Step S104). This can be performed by updating the time-of-flight histogram based on a light reception signal (the reference light reception signal 410, the delayed light reception signal 411, or the like).

Next, the distance measuring device 1 determines whether emission light is emitted in all the phases (Step S105). As a result, in a case where emission light is not emitted in all the phases (Step S105, No), the phase difference is changed (Step S106), and the process proceeds to Step S102. In a case where emission light is emitted in all the phases (Step S105, Yes), the distance measuring device 1 determines whether the measurement is ended (Step S107). This may be determined based on whether the measurement cycle has been performed a predetermined number of times. As a result, in a case where the measurement has not been completed (Step S107, No), the process proceeds to Step S101. In a case where the emission light is emitted in all the phases (Step S107, Yes), the distance detection unit 30 detects the distance (Step S108). This can be performed by generating a second time-of-flight histogram. Thereafter, the distance measuring device 1 outputs the detected distance and ends the distance measuring process.

The distance can be measured by the procedure described above. The measurement cycle may be changed according to the distance measurement range (maximum value of the measurement distance). For example, as described in FIG. 6, in a case where the bin width of the time-of-flight histogram is 1 ns, it is necessary to detect the flight time of 100 ns to set the distance measurement range to 15 m. In this case, at least 100 bins are required, and the measurement cycle needs to be set to at least 100 ns. In a case where the distance measurement range is 150 m, the number of required bins is 1000, and the measurement cycle is at least 1 μs. In this manner, the measurement cycle is changed according to the distance measurement range.

This change (adjustment) of the measurement cycle is performed by the control unit 90 described in FIG. 1. For example, the control unit 90 may change the measurement cycle based on the measurement cycle input by the user of the distance measuring device 1. The control unit 90 can control the light source unit 60 and the time-of-flight detection unit 20 based on the input measurement cycle and cause the light source unit 60 and the time-of-flight detection unit 20 to perform distance measurement in the measurement cycle.

Further, the control unit 90 may adjust the measurement cycle based on the distance measurement range input by the user. In this case, the control unit 90 can calculate the measurement cycle from the distance measurement range and control the light source unit 60 and the time-of-flight detection unit 20 based on the calculated measurement cycle. In this manner, the measurement cycle can be optimized by adjusting the measurement cycle according to the distance measurement range.

Further, the control unit 90 can further control the reference clock signal generation unit 40 to adjust the frequency of the reference clock signal. For example, the control unit 90 can detect an approximate distance to the object 801 and adjust the frequency of the reference clock signal according to the detected distance. When the distance to the object 801 is relatively short, for example, within 3 m, the frequency of the reference clock signal is changed to 4 GHz. As a result, the bin width becomes 0.25 ns, and the accuracy of distance measurement can be improved. In this manner, it is possible to detect an approximate distance to the object 801 by lowering the frequency of the reference clock signal, adjust the reference clock signal according to the detected distance, and measure the distance again with high distance measurement accuracy.

In this manner, the distance measuring device 1 according to the first embodiment of the present disclosure sequentially emits the reference emission light 400 and the delayed emission light 401, 402, and 403 in one measurement cycle to generate a light reception signal, and generates a single time-of-flight histogram. This can shorten the time required for distance measurement. At this time, the distance measuring device 1 emits the reference emission light 400 and the delayed emission light 401, 402, and 403 with different phase differences, detects the reference light reception signal 410 and the delayed reception light signals 411 to 414 in synchronization with the same reference clock signal, and generates a time-of-flight histogram. Since the second time-of-flight histogram having a bin with a width shorter than the detection cycle of the light reception signal is generated from the time-of-flight histogram and the time of flight is detected, the accuracy and resolution of distance measurement can be improved.

### 2. Second Embodiment

The distance measuring device 1 of the first embodiment described above emits emission light having a pulse width substantially equal to the cycle of the reference clock signal. The distance measuring device 1 according to a second embodiment of the present disclosure is different from that of the above-described first embodiment in that the distance measuring device 1 corresponds to emission light having a pulse width longer than the cycle of the reference clock signal.

### [Configuration of Distance Measuring Device]

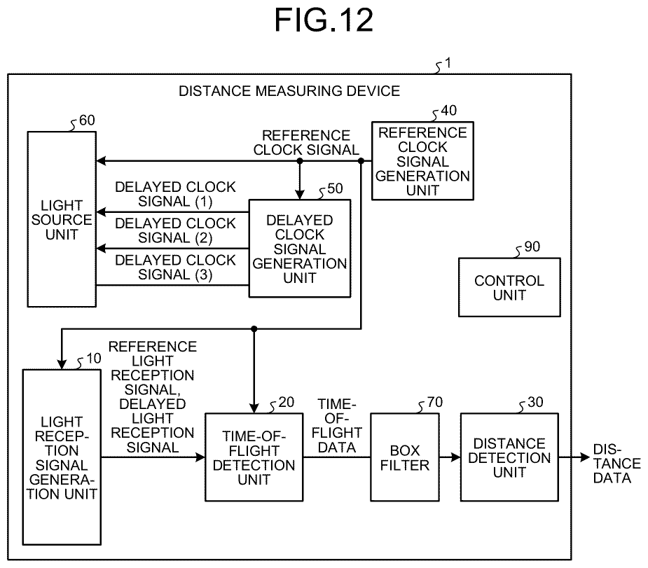

FIG. 12 is a diagram depicting a configuration example of a distance measuring device according to a second embodiment of the present disclosure. The drawing is a block diagram illustrating a configuration example of the distance measuring device 1 as in FIG. 1. The distance measuring device 1 in the drawing is different from the distance measuring device 1 in FIG. 1 in further including a box filter 70.

The box filter 70 is configured as a moving average filter, and detects a moving average of light reception signals. By using the box filter 70 as a box filter having a window function corresponding to the pulse width of emission light, conversion into data of a histogram having one peak can be performed even when the pulse width of the reference light reception signal 410 or the like is longer than the bin width of the time-of-flight histogram.

The configuration of the distance measuring device 1 other than this is the same as the configuration of the distance measuring device 1 in the first embodiment of the present disclosure, and thus description thereof is omitted.

In this manner, the distance measuring device 1 according to the second embodiment of the present disclosure can generate a time-of-flight histogram even when the pulse width of the reference light reception signal 410 or the like is longer than the bin width of the time-of-flight histogram.

### 3. Modification

A modification of the distance measuring device 1 of the first embodiment will be described.

### [Time-of-Flight Histogram]

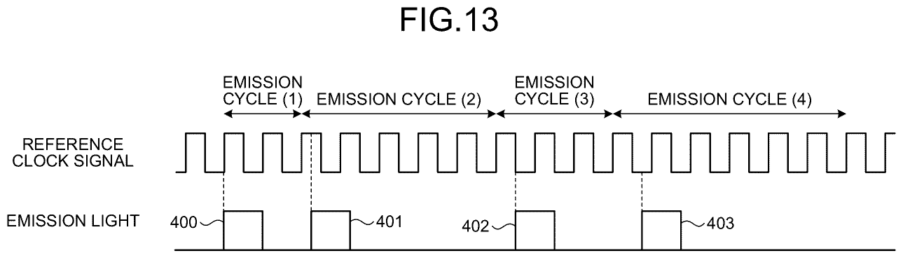

FIG. 13 is a diagram depicting an example of emission light according to a first modification of an embodiment of the present disclosure. The drawing illustrates an example of emission light in the light source unit 60. “Emission cycle” in the drawing represents the emission cycle of the emission light in the light source unit 60 as in FIG. 7. The drawing illustrates an example in which the emission light 400 and the like are emitted in accordance with the emission cycles (1) to (4) set to different cycles. By changing the emission cycle, interference by the plurality of distance measuring devices 1 can be reduced. In addition, side lobes of the emission light can be dispersed.

### [Reference Clock Signal and Delayed Clock Signal]

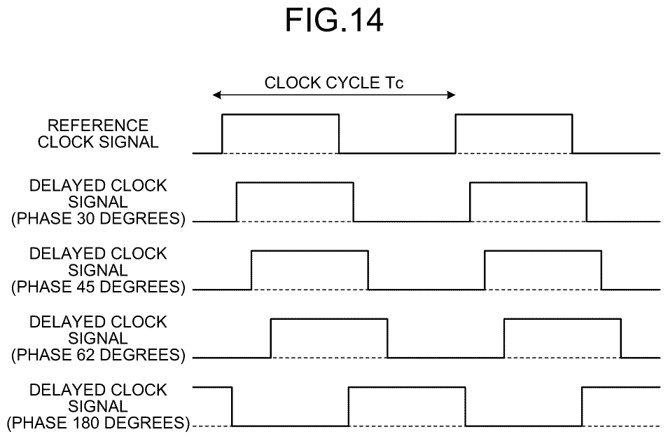

FIG. 14 is a diagram depicting an example of a clock signal according to a second modification of an embodiment of the present disclosure. The delayed clock signal in the drawing is configured as a signal delayed by 30 degrees, 45 degrees, 62 degrees, and 180 degrees from the reference clock signal, respectively. The delayed emission light synchronized with these delayed clock signals is also emission light delayed by 30 degrees, 45 degrees, 62 degrees, and 180 degrees from the reference emission light. In the delayed clock signal of the drawing, the phase difference of the delayed emission light corresponding to the delayed clock signal having the phase delay of 30 degrees, 45 degrees, and 62 degrees is shortened by these delayed clock signals. This makes it possible to generate a high-resolution time-of-flight histogram in the region.

The configuration of the distance measuring device 1 other than this is the same as the configuration of the distance measuring device 1 in the first embodiment of the present disclosure, and thus description thereof is omitted.

The effects described in the present specification are merely examples and are not restrictive of the disclosure herein, and other effects may be achieved.

The present technology may also take the following configurations.

(1)

A distance measuring device comprising:
a light source unit that continuously emits reference emission light emitted in synchronization with a reference clock signal and delayed emission light emitted in synchronization with a delayed clock signal having a delay phase at a same cycle as the reference clock signal in a predetermined emission cycle for every predetermined measurement cycle;
a light reception signal generation unit that includes a light receiving unit that receives reflected light emitted from the light source unit and reflected by an object, detects the reflected light based on the reference emission light and the reflected light based on the delayed emission light in synchronization with the reference clock signal, and generates a reference light reception signal and a delayed light reception signal;
a time-of-flight detection unit that detects time-of-flight data including a reference time of flight based on the generated reference light reception signal and a delayed time of flight based on the generated delayed light reception signal for the every measurement cycle; and a distance detection unit that detects a distance to the object based on the detected time-of-flight data.
   (2)

The distance measuring device according to the above (1), wherein
the time-of-flight detection unit detects, as the time-of-flight data, a time-of-flight histogram representing a time of flight as a frequency, the time-of-flight histogram being represented in a bin in which the reference time of flight and the delayed time of flight are shifted by the emission cycle.
   (3)

The distance measuring device according to the above (2), wherein
the time-of-flight detection unit detects, as the time-of-flight data, the time-of-flight histogram in which a width of the bin is a cycle of the reference clock signal.
   (4)

The distance measuring device according to the above (3), wherein
the distance detection unit generates a second time-of-flight histogram that is the time-of-flight histogram formed based on the time-of-flight histogram and configured to have a width of the bin based on a phase difference between the reference clock signal and the delayed clock signal, and detects the distance based on the generated second time-of-flight histogram.
   (5)

The distance measuring device according to any one of the above (1) to (4), wherein
the light source unit continuously emits a plurality of the delayed emission light in the predetermined emission cycle, the plurality of delayed emission light being emitted in synchronization with a plurality of the delayed clock signals having different phase delays from the reference emission light,
the light reception signal generation unit generates a plurality of delayed light reception signals based on the reference light reception signal and the plurality of delayed emission light, and
the time-of-flight detection unit detects the time-of-flight data including the reference time of flight and a plurality of delayed times of flight based on the plurality of delayed light reception signals.
   (6)

The distance measuring device according to the above (5), wherein
the light source unit emits the reference emission light and the plurality of delayed emission light in synchronization with the reference clock signal and the plurality of delayed clock signals having phase differences at equal intervals, respectively.
   (7)

The distance measuring device according to the above (5), wherein
the light source unit emits a plurality of the delayed emission light in the predetermined emission cycles different from each other.
   (8)

A distance measuring method comprising:
continuously emitting reference emission light emitted in synchronization with a reference clock signal and delayed emission light emitted in synchronization with a delayed clock signal having a delay phase at a same cycle as the reference clock signal in a predetermined emission cycle for every predetermined measurement cycle;
including a light receiving unit that receives reflected light emitted from the light source unit and reflected by an object, detecting the reflected light based on the reference emission light and the reflected light based on the delayed emission light in synchronization with the reference clock signal, and generating a reference light reception signal and a delayed light reception signal;
detecting time-of-flight data including a reference time of flight based on the generated reference light reception signal and a delayed time of flight based on the generated delayed light reception signal for the measurement cycle; and detecting a distance to the object based on the detected time-of-flight data.
   (9)

A distance measuring sensor comprising:
a light reception signal generation unit that includes a light receiving unit that receives reflected light emitted from a light source unit and reflected by an object, the reflected light obtained by continuously emitting reference emission light emitted in synchronization with a reference clock signal and delayed emission light emitted in synchronization with a delayed clock signal having a delay phase at a same cycle as the reference clock signal in a predetermined emission cycle for every predetermined measurement cycle, detects the reflected light based on the reference emission light and the reflected light based on the delayed emission light in synchronization with the reference clock signal, and generates a reference light reception signal and a delayed light reception signal;
a time-of-flight detection unit that detects time-of-flight data including a reference time of flight based on the generated reference light reception signal and a delayed time of flight based on the generated delayed light reception signal for the every measurement cycle; and
a distance detection unit that detects a distance to the object based on the detected time-of-flight data.

### REFERENCE SIGNS LIST

1 DISTANCE MEASURING DEVICE
10 LIGHT RECEPTION SIGNAL GENERATION UNIT
11 LIGHT RECEIVING UNIT
20 TIME-OF-FLIGHT DETECTION UNIT
21 HISTOGRAM GENERATION UNIT
22 HISTOGRAM HOLDING UNIT
30 DISTANCE DETECTION UNIT
31 SECOND HISTOGRAM GENERATION UNIT
32 SECOND HISTOGRAM HOLDING UNIT
33 DISTANCE CALCULATION UNIT
40 REFERENCE CLOCK SIGNAL GENERATION UNIT
50 DELAYED CLOCK SIGNAL GENERATION UNIT
60 LIGHT SOURCE UNIT
90 PIXEL
113 PIXEL ARRAY UNIT

1. A distance measuring device comprising:
a light source unit that continuously emits reference emission light emitted in synchronization with a reference clock signal and delayed emission light emitted in synchronization with a delayed clock signal having a delay phase at a same cycle as the reference clock signal in a predetermined emission cycle for every predetermined measurement cycle;
a light reception signal generation unit that includes a light receiving unit that receives reflected light emitted from the light source unit and reflected by an object, detects the reflected light based on the reference emission light and the reflected light based on the delayed emission light in synchronization with the reference clock signal, and generates a reference light reception signal and a delayed light reception signal;
a time-of-flight detection unit that detects time-of-flight data including a reference time of flight based on the generated reference light reception signal and a delayed time of flight based on the generated delayed light reception signal for the every measurement cycle; and
a distance detection unit that detects a distance to the object based on the detected time-of-flight data.

2. The distance measuring device according to claim 1, wherein
the time-of-flight detection unit detects, as the time-of-flight data, a time-of-flight histogram representing a time of flight as a frequency, the time-of-flight histogram being represented in a bin in which the reference time of flight and the delayed time of flight are shifted by the emission cycle.

3. The distance measuring device according to claim 2, wherein
the time-of-flight detection unit detects, as the time-of-flight data, the time-of-flight histogram in which a width of the bin is a cycle of the reference clock signal.

4. The distance measuring device according to claim 3, wherein
the distance detection unit generates a second time-of-flight histogram that is the time-of-flight histogram formed based on the time-of-flight histogram and configured to have a width of the bin based on a phase difference between the reference clock signal and the delayed clock signal, and detects the distance based on the generated second time-of-flight histogram.

5. The distance measuring device according to claim 1, wherein
the light source unit continuously emits a plurality of the delayed emission light in the predetermined emission cycle, the plurality of delayed emission light being emitted in synchronization with a plurality of the delayed clock signals having different phase delays from the reference emission light,
the light reception signal generation unit generates a plurality of delayed light reception signals based on the reference light reception signal and the plurality of delayed emission light, and
the time-of-flight detection unit detects the time-of-flight data including the reference time of flight and a plurality of delayed times of flight based on the plurality of delayed light reception signals.

6. The distance measuring device according to claim 5, wherein
the light source unit emits the reference emission light and the plurality of delayed emission light in synchronization with the reference clock signal and the plurality of delayed clock signals having phase differences at equal intervals, respectively.

7. The distance measuring device according to claim 5, wherein
the light source unit emits a plurality of the delayed emission light in the predetermined emission cycles different from each other.

8. A distance measuring method comprising:
continuously emitting reference emission light emitted in synchronization with a reference clock signal and delayed emission light emitted in synchronization with a delayed clock signal having a delay phase at a same cycle as the reference clock signal in a predetermined emission cycle for every predetermined measurement cycle;
including a light receiving unit that receives reflected light emitted from the light source unit and reflected by an object, detecting the reflected light based on the reference emission light and the reflected light based on the delayed emission light in synchronization with the reference clock signal, and generating a reference light reception signal and a delayed light reception signal;
detecting time-of-flight data including a reference time of flight based on the generated reference light reception signal and a delayed time of flight based on the generated delayed light reception signal for the measurement cycle; and
detecting a distance to the object based on the detected time-of-flight data.

9. A distance measuring sensor comprising:
a light reception signal generation unit that includes a light receiving unit that receives reflected light emitted from a light source unit and reflected by an object, the reflected light obtained by continuously emitting reference emission light emitted in synchronization with a reference clock signal and delayed emission light emitted in synchronization with a delayed clock signal having a delay phase at a same cycle as the reference clock signal in a predetermined emission cycle for every predetermined measurement cycle, detects the reflected light based on the reference emission light and the reflected light based on the delayed emission light in synchronization with the reference clock signal, and generates a reference light reception signal and a delayed light reception signal;
a time-of-flight detection unit that detects time-of-flight data including a reference time of flight based on the generated reference light reception signal and a delayed time of flight based on the generated delayed light reception signal for the every measurement cycle; and
a distance detection unit that detects a distance to the object based on the detected time-of-flight data.
